(19) United States
(12) Patent Application Publication
(10) Pub. No.: US 2015/0204379 A1
(43) Pub. Date: Jul. 23, 2015

(54) Sliding Stop Rotation Device

(71) Applicant: Chris Dana Adams, Flower Mound, TX (US)

(72) Inventor: Chris Dana Adams, Flower Mound, TX (US)

(21) Appl. No.: 14/161,707

(22) Filed: Jan. 23, 2014

(51) Int. Cl. F16C 11/10

(52) U.S. Cl. CPC F16C 11/103

(57) ABSTRACT

A device is provided, i.e. sliding stop rotation device, to allow for greater range of rotation for mechanical joints containing cabling while preventing cable damage due to over rotation. The sliding stop device comprises an upper collar and lower collar, each of which further comprises two semi-circular rings that are connected to form a circular ring or collar. The upper and lower collars also include a stopping element. The upper collar includes a fixed stop element and the lower collar includes a sliding stop element. The sliding stop element of the lower collar slides back and forth within a defined track. When the fixed top element contacts the sliding stop element, further rotation of the collars with respect to each other is prevented. As a result, the combined assembly of the upper and lower collars allows for 360 degrees of rotation, while preventing rotation beyond that point.

### RELATED U.S. APPLICATION DATA

This application claims priority to Provisional Application No. 61/758,128, filed Jan. 29, 2013.

### FIELD OF THE INVENTION

The present invention relates to mechanical joints used in articulated arms that house cabling, particularly those used to support monitors and equipment in medical settings.

### BACKGROUND OF THE INVENTION

In the fast-paced, stressful world of emergency medicine, time is often of the essence and speed and reliability of medical equipment can be critical. It behooves medical personnel to utilize the most advanced, efficient, and flexible methods of treatment—methods which are often carried out with the help of mechanical aids, or equipment delivery systems (EDS). These systems are quite frequently characterized by articulated arms connected by rotating joints through which electrical/signal-carrying cabling is passed. A crucial factor in optimizing the mobility of said arms lies in the maximization of their rotational range without damaging the cabling. Conventional EDS feature joints typically have no mechanism preventing them from rotating excessively beyond 360 degrees, which can result in damage to the cables.

Alternatively, those. EDS that do have a mechanism limiting the range of rotation utilize a fixed stop at points of rotation which save pass-through cabling from breakage at the cost of enabling 360 degrees of rotational range. This is because the fixed stopping structures take up a portion of the rotational range. In many cases, 30 to 60 degrees of rotational “dead spots” are present in conventional EDS. In order to obtain a greater range of rotation, users often alter their EDS to remove the stopping mechanism, which allows for greater rotation but again makes the EDS susceptible to damage due to over-rotation. Thus, there is a need in the art for a device which simultaneously allows a user to achieve 360 degrees of rotation, while preserving cable integrity within the device's articulated arms/joints.

### SUMMARY OF THE INVENTION

A device is provided, i.e. sliding stop rotation device, to allow for greater range of rotation for mechanical joints containing cabling while preventing cable damage due to over rotation. The sliding stop device comprises an upper collar and lower collar, each of which further comprises two semi-circular rings that are connected to form a circular ring or collar. The upper and lower collars also include a stopping element. The upper collar includes a fixed stop element and the lower collar includes a sliding stop element. The sliding stop element of the lower collar slides back and forth within a defined track. When the fixed top element contacts the sliding stop element, further rotation of the collars with respect to each other is prevented. As a result, the combined assembly of the upper and lower collars allows for 360 degrees of rotation, while preventing rotation beyond that point.

### BRIEF DESCRIPTION OF THE DRAWINGS

FIG. 1 illustrates a side view of a fully assembled sliding stop device attached to an existing suspension or Equipment Delivery System (EDS).

FIG. 2 illustrates a top view of the two disassembled split ring collars which comprise the sliding stop device, and the sliding action of the stop housed within the lower collar.

FIG. 3 illustrates a close-up side view of both assembled split ring collars which comprise the sliding stop device, and the sliding action of the stop housed within the lower collar.

### DETAILED DESCRIPTION

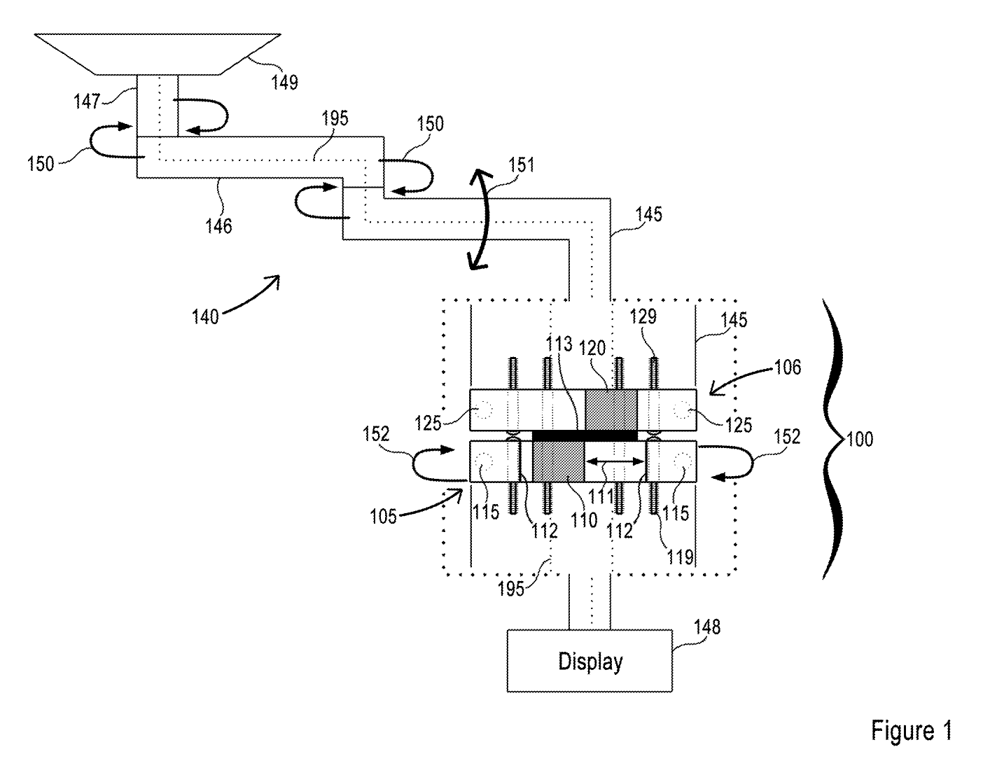

The present invention provides a method of mechanical enhancement for medical devices, e.g. suspension and Equipment Delivery Systems (EDS), in operating rooms and similar settings. Such devices consist of adjustable arms that change position via multi-axis rotation. The cabling passed through the interiors of these structures is subsequently subject to said rotation, making it susceptible to breakage in instances of over-rotation, such as 360 degree rotation. Current methods address this issue by applying fixed stops at points of rotation; the result may hinder ranges of movement by up to 30 degrees by creating a rotational “dead spot.” The sliding stop addresses a need for 360 degree rotation while preserving cable integrity. FIG. 1 illustrates a side view of a fully assembled sliding stop device attached to an existing suspension or Equipment Delivery System (EDS). A series of articulated arms 140 (i.e., 146, 147, and 145) are attached to the ceiling at base 149 and rotate at joints 150 and allow for the movement and adjustment of display 148. Within the articulated arms are a plurality of cables 195 that pass from the base 149 in the ceiling to the display 148. The cables 195 can include power cables, as well as cables that contain water or air. Often, an EDS can include a variety of different devices that require different types of cabling. The sliding stop device 100 is attached to the free end of the series of arms and connects to the display 148, which can be a video monitor used in surgical settings. The sliding stop device 100 provides for rotation of the display 148 without damaging the cables within the arms by over-rotation.

The sliding stop device 100 comprises a upper collar 106 and lower collar 105. Both collars further comprise unique stops—the upper collar housing a fixed stop 120 and the lower collar housing a sliding stop 110. Motion arrow 111 indicates the back and forth movement of the sliding stop 110—a motion executed along a track/channel which terminates in sliding path boundaries 112. This sliding distance allows for at least 360 degrees of rotation. The rotation of the upper and lower collars is indicated by motion arrow 152. Of course, the device can be configured to provide other ranges of rotation as desired. The collars themselves cannot rotate about one another when the fixed stop hits the sliding stop, therefore they would each need to be fixed to the existing suspensions or EDS. An example of an install solution would be bolting the collar system to the fixture. In this scenario, the upper and lower collars 105 and 106 are attached to the articulated arm 145 at its point of rotation via bolts/screws 119 and 129, respectively. Alternative methods of applying the sliding stop shall be on a case by case basis. The composition of some or all sliding stop elements should be that of a hard, durable material such as a metal alloy (e.g., steel). A strong composition with the advantage of rust-resistance would prove invaluable in operating room settings and the like. The sliding stop can be used on any piece of equipment which currently requires that a stop be present due to rotation of cabling 195.

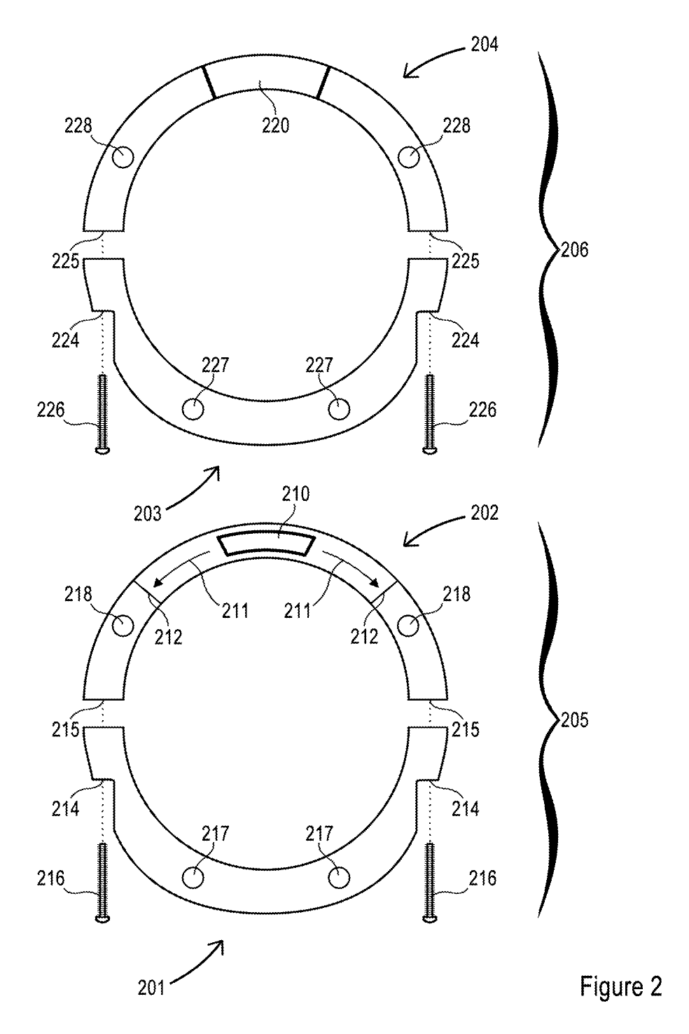

FIG. 2 illustrates a top view of the two disassembled split ring collars which comprise the sliding stop device, and the sliding action of the stop housed within the lower collar. The upper collar 206 is formed by the joining of the two halves of the split ring—the primary top half 204 and the secondary top half 203. Likewise, the lower collar 205 consists of a primary bottom half 202 and a secondary bottom half 201. In joining the disassembled upper collar 206, the user finds top joining pass-throughs 224, through which top joining bolts/screws 226 are inserted to mate with top threaded inserts 225. In the same way, the disassembled lower collar 205 possesses bottom joining pass-throughs 214, through which bottom joining bolts/screws 216 are inserted to mate with bottom threaded inserts 215. This joining method effectively assembles the device around the desired rotation point of an EDS' articulated arm. All that remains is for the user to attach the device to the EDS itself. For this purpose, both split ring collars possess pass-through holes that accept bolts/screws which join the device to an existing structure/EDS. The upper collar 206 has primary top pass-throughs 228 on the primary top half 204, and secondary top pass-throughs 227 on the secondary top half 203. Likewise, the lower collar 205 has primary bottom pass-throughs 218 on the primary bottom half 202, and secondary bottom pass-throughs 217 on the secondary bottom half 201.

Each split ring collar further comprises a stopping element. The upper collar 206 contains the fixed stop 220, housed within its primary top half 204. More uniquely, the lower collar 205 contains the sliding stop 210 itself, housed within its primary bottom half 202. Here lies the heart of the device, and its means for successfully increasing rotational range. Sliding along its track/channel element, the sliding stop 210 moves back and forth along the curvature or arc-shape of the primary bottom half 202, in a path indicated by motion arrows 211. The sliding action of the sliding stop 210 has the benefit of eliminating “dead space” in the 360 degrees of rotation because the thickness of the stopping elements (which create the dead space) is offset by the sliding action of the sliding stop 210, thereby allowing for full 360 degree rotation whereas in conventional fixed stop joints the thickness of the stopping structure creates dead space that prevent a full range of 360 degree rotation. Thus, the sliding stop element 210 is advantageous in providing positional flexibility while preserving the integrity of the cabling within the EDS by preventing damage caused by over-rotation. The amount of travel of the sliding stop element 210 can be set as desired, but may be for example approximately 90 degrees of arc, depending on the thickness of the sliding stop element 210 and fixed stop element 220 (i.e., the range of rotation that is taken up by the sliding stop element).

Thus, the upper collar comprises two semi-circular components, one of which includes a fixed stopping element attached to a bottom surface of the semi-circular component. Similarly, the lower collar is comprised of two semi-circular components, one of which includes a sliding stopping element that travels within a defined track within the top surface of the semi-circular component. The sliding stopping element is configured to contact the fixed stopping element upon rotation of the upper collar with respect to the lower collar, and to prevent any further rotation when the sliding stopping element reaches the end of the track. The sliding stop element can thus increase an EDS' rotational range by whatever value desired, e.g. 360 degrees of rotation. FIG. 2 depicts the device's added rotational range with the area in the primary bottom half 202 bounded by sliding range boundaries 212 as defined by the track/channel. The sliding stop element makes contact with these boundaries upon completing rotation of 360 degrees.

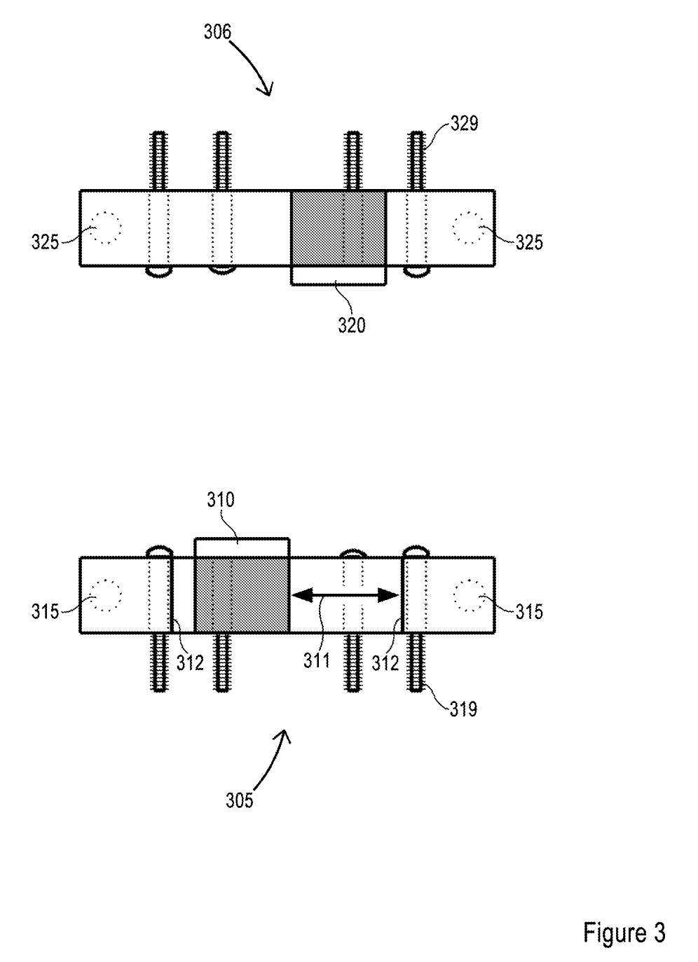

FIG. 3 illustrates a close-up side view of both assembled split ring collars which comprise the sliding stop device, and the sliding action of the stopping element housed within the lower collar. This figure includes exemplary attachment means, in the form of threaded holes and screws, by which the sliding stop device is installed on an EDS or other application. The fixed stopping element 320 is attached to the bottom surface of the upper collar 306. The sliding stopping element 310 is attached to the upper surface of lower collar 305. Thus the collars are installed such that the stopping elements face one another and can interact to cease the rotation between the upper and lower collars. In this figure, it is implied that both top threaded inserts 325 and bottom threaded inserts 315 have accepted bolts/screws, effectively joining both halves of each split ring collar together. With respect to the device functionality, when the fixed stop 320 of the upper collar 306 makes contact with the sliding stop 310 (housed within the lower collar 305) it causes the sliding stop 310 to move along the track in the given direction of rotation as indicated by motion arrow 311. Upon articulated arm rotation, the fixed stop 320 will eventually contact with the sliding stop 310, as the top and lower collars are rotating with respect to each other. The sliding stop would then be “pushed” along the track path 311 until it reaches the end of the track 312 opposite its starting point, at which time the rotation would cease. This creates a substantial additional range of motion as compared to traditional fixed-stop-only mechanisms. In an operating room or similar setting, a user who adjusts the articulated arm of an EDS fitted with the sliding stop device would be enabled to rotate the EDS a full 360 degree path of motion without the risk of over-rotation which could damage the cables within the arms/joints.

While there have been described herein what are considered to be preferred and exemplary embodiments of the present invention, other modifications of the invention shall be apparent to those skilled in the art from the teachings herein. For example, the relative dimensions of the device may be altered while keeping within the spirit and teachings of the invention. It is therefore desired to be secured, in the appended claims all such modifications as fall within the spirit and scope of the invention.

What is claimed is:

1. A rotational collar device comprising:
an upper collar comprised of two semi-circular components, wherein one of said semi-circular components includes a fixed stopping, element attached to a bottom surface of the semi-circular component;
a lower collar comprised of two semi-circular components, wherein one of said semi-circular components includes a sliding stopping element that is attached to a track within a top surface of the semi-circular component and slides within the track;
wherein said lower collar rotates with respect to the upper collar; and
wherein the sliding stopping element is configured to contact the fixed stopping, element upon rotation of the upper collar with respect to the lower collar, said contact preventing any further rotation when the sliding stopping element reaches the end of the track.

2. A rotational collar device comprising:
an upper collar comprised of a ring-shaped body that includes a fixed stopping element on bottom surface of the upper collar;
a lower collar comprised of a ring-shaped body that includes a sliding stopping element on a top surface of the lower collar, wherein said sliding stopping element moves along the track;
wherein said lower collar rotates with respect to the upper collar; and
wherein the sliding stopping element is configured to contact the fixed stopping element upon rotation of the upper collar with respect to the lower collar, said contact preventing any further rotation when the sliding stopping element reaches the end of the track.
